(19) United States
(12) Patent Application Publication
(10) Pub. No.: US 2026/0320910 A1
(43) Pub. Date: Oct. 15, 2026

(54) ILLUMINATION PROCESSING

(71) Applicant: TENCENT TECHNOLOGY (SHENZHEN) COMPANY LIMITED, Shenzhen (CN)

(72) Inventor: Qihong LI, Shenzhen (CN)

(73) Assignee: TENCENT TECHNOLOGY (SHENZHEN) COMPANY LIMITED, Shenzhen (CN)

(21) Appl. No.: 19/684,679

(22) Filed: May 21, 2026

Related U.S. Application Data
(63) Continuation of application No. PCT/CN2025/108826, filed on Jul. 16, 2025.

(30) Foreign Application Priority Data
Aug. 7, 2024 (CN) 202411083081.6

(51) Int. Cl. G06T 15/50; G06T 15/06

(52) U.S. Cl. CPC G06T 15/506; G06T 15/06

(57) ABSTRACT

In an illumination processing method, a voxel texture of a to-be-rendered scene is obtained. In the method, respective indirect illumination of each pixel in an allocated map of the to-be-rendered scene is obtained based on a plurality of first rays emitted by the pixel and the indirect illumination information of corresponding voxels in the voxel texture. In the method, for a plurality of pixels in the allocated map, the indirect illumination of the plurality of pixels is stored to obtain an illumination map of the to-be-rendered scene. In the method, illumination sampling is performed on the illumination map based on one or more to-be-rendered positions of one or more to-be-rendered objects in the to-be-rendered scene and one or more allocated areas of the one or more to-be-rendered objects in the allocated map, to obtain indirect illumination of the one or more to-be-rendered positions.

### RELATED APPLICATIONS

The present application is a continuation of International Application No. PCT/CN2025/108826, filed on Jul. 16, 2025, which claims priority to Chinese Patent Application No. 202411083081.6, filed on Aug. 7, 2024, and entitled “INDIRECT ILLUMINATION PROCESSING METHOD BASED ON RENDERING SCENE AND RELATED APPARATUS.” The entire disclosures of the prior applications are hereby incorporated by reference.

### FIELD OF THE TECHNOLOGY

This disclosure relates to the field of computer technologies, including indirect illumination processing based on a rendering scene.

### BACKGROUND

In some applications, global illumination may be calculated for illumination rendering based on a rendering scene. The global illumination includes direct illumination of a scene light source and indirect illumination after a plurality of bounces of a scene ray. Because the indirect illumination may correspond to a plurality of segments of propagation of the scene ray, calculation of the indirect illumination may be resource demanding and may affect the rendering performance.

In a related example, an indirect illumination calculation method based on a rendering scene may include generating a screen probe or a surface finite element based on geometry information of a vertex in a geometry cache of a to-be-rendered scene and performing indirect illumination calculation, to obtain indirect illumination of the rendering scene.

However, in the foregoing method, generating the screen probe or the surface finite element based on the geometry information of the vertex and performing indirect illumination calculation may be cumbersome and complex, which may demand a relatively large calculation amount and may result in relatively low calculation efficiency for a rendering scene.

### SUMMARY

The present disclosure provides an indirect illumination processing method based on a rendering scene and a related apparatus. A screen probe or a surface finite element may not need to be generated depending on geometry information of a vertex in a geometry cache of a to-be-rendered scene, to perform indirect illumination calculation, so that the indirect illumination calculation may be relatively simple and direct, which may in turn save more time and improve efficiency of indirect illumination calculation for a rendering scene.

According to one aspect, an embodiment of this disclosure provides an illumination processing method. In the method, a voxel texture of a to-be-rendered scene is obtained, the voxel texture including indirect illumination information of each voxel in a voxelized scene of the to-be-rendered scene. In the method, respective indirect illumination of each pixel in an allocated map of the to-be-rendered scene is obtained based on a plurality of first rays emitted by the pixel and the indirect illumination information of corresponding voxels in the voxel texture. In the method, for a plurality of pixels in the allocated map, the indirect illumination of the plurality of pixels is stored to obtain an illumination map of the to-be-rendered scene. In the method, illumination sampling is performed on the illumination map based on one or more to-be-rendered positions of one or more to-be-rendered objects in the to-be-rendered scene and one or more allocated areas of the one or more to-be-rendered objects in the allocated map, to obtain indirect illumination of the one or more to-be-rendered positions, the to-be-rendered scene being rendered for display based on the indirect illumination of the one or more to-be-rendered positions.

According to one aspect, an embodiment of this disclosure provides an illumination processing apparatus. The apparatus includes processing circuitry configured to obtain a voxel texture of a to-be-rendered scene, the voxel texture including indirect illumination information of each voxel in a voxelized scene of the to-be-rendered scene. The processing circuitry is configured to obtain respective indirect illumination of each pixel in an allocated map of the to-be-rendered scene based on a plurality of first rays emitted by the pixel and the indirect illumination information of corresponding voxels in the voxel texture. The processing circuitry is configured to store, for a plurality of pixels in the allocated map, the indirect illumination of the plurality of pixels, to obtain an illumination map of the to-be-rendered scene. The processing circuitry is configured to perform illumination sampling on the illumination map based on one or more to-be-rendered positions of one or more to-be-rendered objects in the to-be-rendered scene and one or more allocated areas of the one or more to-be-rendered objects in the allocated map, to obtain indirect illumination of the one or more to-be-rendered positions, the to-be-rendered scene being rendered for display based on the indirect illumination of the one or more to-be-rendered positions.

According to one aspect, an embodiment of this disclosure provides a non-transitory computer-readable storage medium. The non-transitory computer-readable storage medium stores instructions, which when executed by a processor, cause the processor to perform an illumination processing method. In the method, a voxel texture of a to-be-rendered scene is obtained, the voxel texture including indirect illumination information of each voxel in a voxelized scene of the to-be-rendered scene. In the method, respective indirect illumination of each pixel in an allocated map of the to-be-rendered scene is obtained based on a plurality of first rays emitted by the pixel and the indirect illumination information of corresponding voxels in the voxel texture. In the method, for a plurality of pixels in the allocated map, the indirect illumination of the plurality of pixels is stored to obtain an illumination map of the to-be-rendered scene. In the method, illumination sampling is performed on the illumination map based on one or more to-be-rendered positions of one or more to-be-rendered objects in the to-be-rendered scene and one or more allocated areas of the one or more to-be-rendered objects in the allocated map, to obtain indirect illumination of the one or more to-be-rendered positions, the to-be-rendered scene being rendered for display based on the indirect illumination of the one or more to-be-rendered positions.

According to one aspect, an embodiment of this disclosure provides an indirect illumination processing method based on a rendering scene, the method including: obtaining a voxel texture of a to-be-rendered scene, the voxel texture including indirect illumination information of each voxel in a voxelized scene of the to-be-rendered scene; performing, according to a plurality of first rays emitted by each pixel in an allocated map of the to-be-rendered scene, illumination collection on indirect illumination corresponding to a voxel in the voxel texture, to obtain indirect illumination of each pixel; storing, for a plurality of pixels in the allocated map, indirect illumination respectively corresponding to the plurality of pixels, to obtain an illumination map of the to-be-rendered scene; and performing illumination sampling on the illumination map according to a to-be-rendered position of a to-be-rendered object in the to-be-rendered scene and an allocated area of the to-be-rendered object in the allocated map, to obtain indirect illumination of the to-be-rendered position.

According to another aspect, an embodiment of this disclosure provides a rendering scene-based indirect illumination processing apparatus, including: an obtaining unit, a collection unit, a storage unit, and a sampling unit, the obtaining unit being configured to obtain a voxel texture of a to-be-rendered scene; the voxel texture including indirect illumination information of each voxel in a voxelized scene of the to-be-rendered scene; the collection unit being configured to perform, according to a plurality of first rays emitted by each pixel in an allocated map of the to-be-rendered scene, illumination collection on indirect illumination corresponding to voxels in the voxel texture, to obtain indirect illumination of each pixel; the storage unit being configured to store, for a plurality of pixels in the allocated map, indirect illumination respectively corresponding to the plurality of pixels, to obtain an illumination map of the to-be-rendered scene; and the sampling unit being configured to perform illumination sampling on the illumination map according to a to-be-rendered position of a to-be-rendered object in the to-be-rendered scene and an allocated area of the to-be-rendered object in the allocated map, to obtain indirect illumination of the to-be-rendered position.

According to another aspect, an embodiment of this disclosure provides a computer device, the computer device including processing circuitry (e.g., a processor) and a memory (e.g., including a non-transitory computer-readable storage medium): the memory being configured to store a computer program and transmit the computer program to the processor; and the processor being configured to perform, according to instructions in the computer program, the method according to one or more aspects of this disclosure.

According to another aspect, an embodiment of this disclosure provides a non-transitory computer-readable storage medium, the non-transitory computer-readable storage medium being configured to store a computer program, and when the computer program is run on a computer device, the computer device being caused to perform the method according to one or more aspects of this disclosure.

According to another aspect, an embodiment of this disclosure provides a computer program product, including a computer program, the computer program, when being run on a computer device, causing the computer device to perform the method according to one or more aspects of this disclosure.

In some aspects, a voxel texture formed by indirect illumination information of each voxel in a voxelized scene of a to-be-rendered scene is first obtained; then a plurality of indirect illumination corresponding to a plurality of voxels in the voxel texture is collected based on a plurality of first rays emitted by each pixel in an allocated map of the to-be-rendered scene, to obtain indirect illumination of each pixel; and for a plurality of pixels in the allocated map, a plurality of indirect illumination corresponding to the plurality of pixels is stored, to obtain an illumination map of the to-be-rendered scene. In this manner, based on the indirect illumination provided by the voxels in the voxel texture of the to-be-rendered scene, for the allocated map of the to-be-rendered scene, the indirect illumination of the voxels in the voxel texture is collected based on the plurality of first rays emitted by the pixel and is correspondingly stored, so that illumination baking may be rapidly implemented, to obtain the illumination map of the to-be-rendered scene. The illumination map may be sampled based on a to-be-rendered position of a to-be-rendered object in the to-be-rendered scene and a position offset and an allocated size of the to-be-rendered object in the allocated map, to obtain indirect illumination of the to-be-rendered position. In this manner, based on the indirect illumination provided by the pixel in the illumination map of the to-be-rendered scene, for the to-be-rendered position of the to-be-rendered object in the to-be-rendered scene, indirect illumination of a corresponding pixel in the illumination map may be sampled based on the position offset and the allocated size of the to-be-rendered object in the allocated map, to rapidly obtain the indirect illumination of the to-be-rendered position. Based on this, according to the method, illumination baking is rapidly implemented based on an allocated map of a to-be-rendered scene and depending on indirect illumination provided by voxels in a voxel texture of the to-be-rendered scene, to obtain an illumination map of the to-be-rendered scene. The illumination map is sampled based on a to-be-rendered position of a to-be-rendered object in the to-be-rendered scene and depending on a position offset and an allocated size of the to-be-rendered object in the allocated map, and indirect illumination calculation is rapidly implemented, to obtain indirect illumination of the to-be-rendered position. In other words, according to the method, indirect illumination calculation is performed without depending on generation of the screen probe or the surface finite element based on the geometry information of the vertex in the geometry cache of the to-be-rendered scene, so that indirect illumination calculation is relatively simple and direct, which may save more time, and indirect illumination calculation efficiency based on a rendering scene may be improved.

### BRIEF DESCRIPTION OF THE DRAWINGS

FIG. 1 is a schematic diagram of a system of an indirect illumination processing method based on a rendering scene according to an embodiment of this disclosure.

FIG. 2 is a flowchart of an indirect illumination processing method based on a rendering scene according to an embodiment of this disclosure.

FIG. 3 is a schematic diagram of an illumination map of a to-be-rendered scene according to an embodiment of this disclosure.

FIGS. 4A and 4B are schematic diagrams of different rendering effects of a to-be-rendered scene according to an embodiment of this disclosure.

FIG. 5 is a schematic diagram of a voxelized scene of a to-be-rendered scene according to an embodiment of this disclosure.

FIG. 6 is a schematic diagram of a rendering effect of a to-be-rendered scene after a scene light source changes according to an embodiment of this disclosure.

FIGS. 7A and 7B are portions of a flowchart of another indirect illumination processing method based on a rendering scene according to an embodiment of this disclosure.

FIG. 8 is a structural diagram of an indirect illumination processing apparatus based on a rendering scene according to an embodiment of this disclosure.

FIG. 9 is a structural diagram of a server according to an embodiment of this disclosure.

FIG. 10 is a structural diagram of a terminal according to an embodiment of this disclosure.

### DETAILED DESCRIPTION

The following describes embodiments of this disclosure with reference to the accompanying drawings.

Descriptions of terms in this disclosure are provided as examples only and are not intended to limit the scope of the disclosure.

In some related examples, in an illumination rendering process based on a rendering scene, a screen probe or a surface finite element is generated based on geometry information of a vertex in a geometry cache of a to-be-rendered scene and indirect illumination calculation is performed, to obtain indirect illumination of the rendering scene. However, generating the screen probe or the surface finite element based on the geometry information of the vertex and performing indirect illumination calculation may be cumbersome and complex, and a relatively large calculation amount may require more time, which may result in relatively low indirect illumination calculation efficiency based on a rendering scene.

An embodiment of this disclosure provides an indirect illumination processing method based on a rendering scene. Illumination baking is rapidly implemented based on an allocated map of a to-be-rendered scene and depending on indirect illumination provided by voxels in a voxel texture of the to-be-rendered scene, to obtain an illumination map of the to-be-rendered scene; and for a to-be-rendered position of a to-be-rendered object in the to-be-rendered scene, the illumination map is sampled depending on a position offset and an allocated size of the to-be-rendered object in the allocated map, and indirect illumination calculation is rapidly implemented, to obtain indirect illumination of the to-be-rendered position. In other words, according to the method, indirect illumination calculation is performed without depending on generation of the screen probe or the surface finite element based on the geometry information of the vertex in the geometry cache of the to-be-rendered scene, so that indirect illumination calculation is relatively simple and direct, which may save more time, and indirect illumination calculation efficiency based on a rendering scene may be improved.

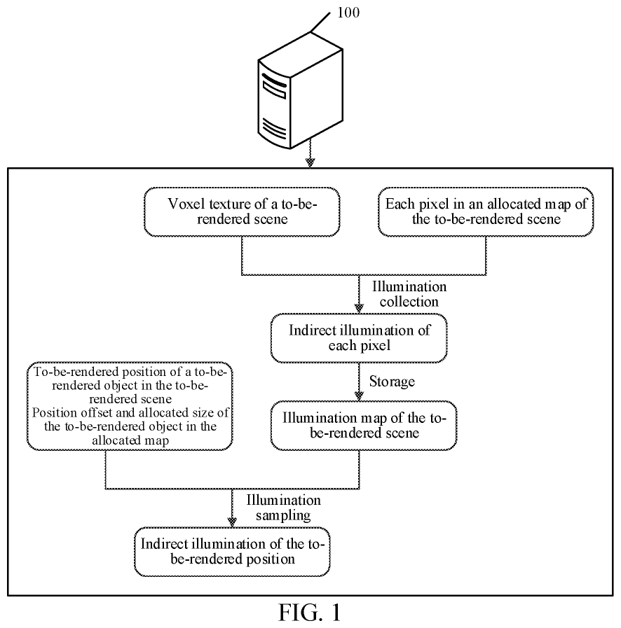

Next, a system architecture of an indirect illumination processing method based on a rendering scene is described. FIG. 1 is a schematic diagram of a system of an indirect illumination processing method based on a rendering scene according to an embodiment of this disclosure. The system includes a computer device 100. The computer device 100 is configured to perform the indirect illumination processing method based on a rendering scene.

The computer device 100 obtains a voxel texture of a to-be-rendered scene, the voxel texture including indirect illumination information of each voxel in a voxelized scene of the to-be-rendered scene.

In an example, the to-be-rendered scene is a scene X. The computer device 100 obtains a voxel texture formed by indirect illumination information of each voxel in a voxelized scene of the scene X, the voxel texture being a texture X. The texture X includes a plurality of voxels in the voxelized scene of the scene X and a plurality of indirect illumination corresponding to the plurality of voxels.

The computer device 100 performs, according to a plurality of first rays emitted by each pixel in an allocated map of the to-be-rendered scene, illumination collection on a plurality of indirect illumination corresponding to a plurality of voxels in the voxel texture, to obtain indirect illumination of each pixel.

In an example, based on the foregoing example, the allocated map of the to-be-rendered scene is a map X of the scene X. The computer device 100 collects, based on a plurality of first rays emitted by each pixel in the map X of the scene X, a plurality of indirect illumination corresponding to the plurality of voxels in the texture X, to obtain indirect illumination of each pixel.

The computer device 100 stores, for a plurality of pixels in the allocated map, a plurality of indirect illumination corresponding to the plurality of pixels, to obtain an illumination map of the to-be-rendered scene.

In an example, based on the foregoing example, the computer device 100 stores, for a plurality of pixels in the map X, a plurality of indirect illumination corresponding to the plurality of pixels, to obtain an illumination map of the scene X, the illumination map being a map X′.

The computer device 100 performs illumination sampling on the illumination map according to a to-be-rendered position of a to-be-rendered object in the to-be-rendered scene and a position offset and an allocated size of the to-be-rendered object in the allocated map, to obtain indirect illumination of the to-be-rendered position.

In an example, based on the foregoing example, the to-be-rendered object is an object, and the to-be-rendered position of the to-be-rendered object in the to-be-rendered scene is texture coordinates (u, v) of the object in the scene X. The computer device 100 samples the map X′ based on the texture coordinates (u, v) of the object in the scene X, a position offset and an allocated size of the object in the map X, to obtain indirect illumination of (u, v).

In other words, based on the indirect illumination provided by the voxels in the voxel texture of the to-be-rendered scene, for the allocated map of the to-be-rendered scene, the indirect illumination of the voxels in the voxel texture is collected based on the plurality of first rays emitted by the pixel and is correspondingly stored, so that illumination baking may be rapidly implemented, to obtain the illumination map of the to-be-rendered scene. Based on the indirect illumination provided by the pixel in the illumination map of the to-be-rendered scene, for the to-be-rendered position of the to-be-rendered object in the to-be-rendered scene, indirect illumination of a corresponding pixel in the illumination map may be sampled based on the position offset and the allocated size of the to-be-rendered object in the allocated map, to rapidly obtain the indirect illumination of the to-be-rendered position.

In this disclosure, the computer device may be a server or a terminal. The method provided in this disclosure may be independently performed by the terminal or the server, or may be cooperatively performed by the terminal and the server. When a method provided in this disclosure is independently performed by the terminal or the server, an execution method is similar to that in FIG. 1, and the computer device may correspond to the terminal or the server. In addition, when a method provided in this disclosure is performed cooperatively by the terminal and the server, operations that need to be embodied on a front-end interface may be performed by the terminal, and some operations that need to be calculated on a back-end and do not need to be embodied on the front-end interface may be performed by the server.

The terminal may be a smartphone, a tablet computer, a notebook computer, a desktop computer, an intelligent voice interaction device, a vehicle-mounted terminal, an extended reality device, an aircraft, or the like, but is not limited thereto. The server may be an independent physical server, or may be a server cluster or a distributed system including a plurality of physical servers, or may be a cloud server providing a cloud computing service, but is not limited thereto. The terminal and the server may be directly or indirectly connected in a wired or wireless communication manner. This is not limited in this disclosure herein. For example, the terminal and the server may be connected through a network, and the network may be a wired or wireless network.

Next, the indirect illumination processing method based on a rendering scene provided in one or more embodiments of this disclosure is described in further detail with reference to the accompanying drawings based on an example in which the computer device performs the method provided in one or more embodiments of this disclosure.

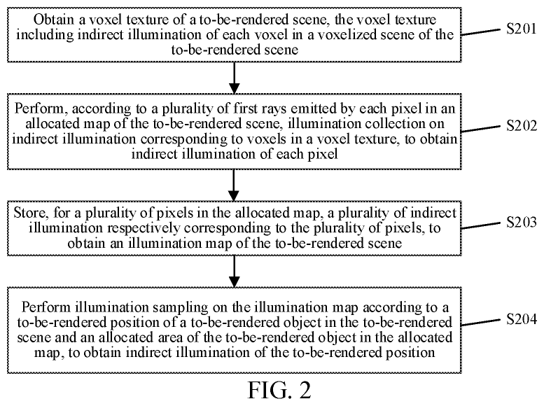

FIG. 2 is a flowchart of an indirect illumination processing method based on a rendering scene according to an embodiment of this disclosure. The method includes the following operations.

S201: Obtain a voxel texture of a to-be-rendered scene, the voxel texture including indirect illumination information of each voxel in a voxelized scene of the to-be-rendered scene.

S202: Perform, according to a plurality of first rays emitted by each pixel in an allocated map of a to-be-rendered scene, illumination collection on indirect illumination corresponding to voxels in the voxel texture, to obtain indirect illumination of each pixel. For example, respective indirect illumination of each pixel in an allocated map of the to-be-rendered scene is obtained based on a plurality of first rays emitted by the pixel and the indirect illumination information of corresponding voxels in the voxel texture.

S203: Store, for a plurality of pixels in the allocated map, indirect illumination respectively corresponding to the plurality of pixels, to obtain an illumination map of the to-be-rendered scene. For example, for a plurality of pixels in the allocated map, the indirect illumination of the plurality of pixels is stored, to obtain an illumination map of the to-be-rendered scene.

In a related technology, in an illumination rendering process based on a rendering scene, a screen probe or a surface finite element is generated based on geometry information of a vertex in a geometry cache of a to-be-rendered scene, and indirect illumination calculation is performed, to obtain indirect illumination of the rendering scene. However, generating the screen probe or the surface finite element based on the geometry information of the vertex, and performing indirect illumination calculation may be cumbersome and complex, and a relatively large calculation amount may require more time, which may result in relatively low indirect illumination calculation efficiency based on a rendering scene.

Therefore, in this disclosure, to perform indirect illumination calculation without depending on generation of the screen probe or the surface finite element based on the geometry information of the vertex in the geometry cache of the to-be-rendered scene, considering that indirect illumination may be collected based on a voxel in a voxelized scene of the to-be-rendered scene, a voxel texture is correspondingly formed and stored, and a pixel in an allocated map of the to-be-rendered scene has a correspondence with the voxel in the voxelized scene, so that indirect illumination of a related voxel may be collected based on the pixel in the allocated map, to quickly obtain accurate indirect illumination related to the pixel.

A pixel in the allocated map of the to-be-rendered scene may represent a surface point of a to-be-rendered object in the to-be-rendered scene. Indirect illumination corresponding to voxels in a voxel texture may be collected based on a plurality of rays emitted by the pixel and correspondingly stored, so that illumination baking may be rapidly implemented to obtain an illumination map, which may be usable for implementing indirect illumination calculation based on a rendering scene. Based on this, a voxel texture formed by indirect illumination information of each voxel in a voxelized scene of a to-be-rendered scene is first obtained; then a plurality of indirect illumination corresponding to a plurality of voxels in the voxel texture is collected based on a plurality of first rays emitted by each pixel in an allocated map of the to-be-rendered scene, to obtain indirect illumination of each pixel; and indirect illumination is stored for a corresponding pixel in the allocated map, to obtain an illumination map of the to-be-rendered scene.

The to-be-rendered scene is a scene on which illumination rendering is to be performed. The voxel texture of the to-be-rendered scene is a three-dimensional texture formed by indirect illumination information of each voxel stored for each voxel in the voxelized scene of the to-be-rendered scene. The voxelized scene of the to-be-rendered scene is a scene in which a voxel represents each to-be-rendered object in the to-be-rendered scene. Each voxel in the voxelized scene of the to-be-rendered scene is each three-dimensional grid of each to-be-rendered object in the to-be-rendered scene. The indirect illumination information of each voxel is hybrid illumination of direct illumination of a scene light source and stored illumination of another voxel that are collected based on a plurality of rays emitted by each voxel. The allocated map of the to-be-rendered scene is a two-dimensional map obtained by allocating an area for a resolution of each to-be-rendered object in the to-be-rendered scene in an initial map. Each pixel in the allocated map of the to-be-rendered scene represents a surface point of a to-be-rendered object in the to-be-rendered scene. The indirect illumination of each pixel is hybrid illumination of a plurality of indirect illumination that corresponds to a plurality of voxels in the voxel texture and that is collected based on a plurality of rays emitted by each pixel. The illumination map of the to-be-rendered scene is a two-dimensional map obtained by storing the indirect illumination of each pixel for each pixel in the allocated map of the to-be-rendered scene.

In S201 to S203, because each voxel in the voxel texture of the to-be-rendered scene provides indirect illumination, and the allocated map and the voxelized scene both are from the to-be-rendered scene, a pixel in the allocated map may be converted into the voxelized scene, to emit first rays. A position in the voxelized scene after conversion is used as a position of the pixel, the position is used as a start point of the first ray, and a plurality of first rays are emitted from the position to a surrounding area. The first ray may be set to have penetrability. In other words, the first ray continues to move in an original direction after being in contact with a 1st voxel, and illumination collection may be performed on indirect illumination corresponding to a voxel that is in contact with the first ray and that is in the voxel texture in the voxelized scene, to obtain indirect illumination corresponding to the pixel.

Therefore, a plurality of indirect illumination corresponding to a plurality of voxels in the voxel texture is collected based on a plurality of first rays emitted by each pixel in the allocated map of the to-be-rendered scene and correspondingly stored, so that illumination baking may be rapidly implemented, to obtain the illumination map of the to-be-rendered scene, so as to provide the illumination map that may be sampled for subsequent indirect illumination calculation based on a rendering scene.

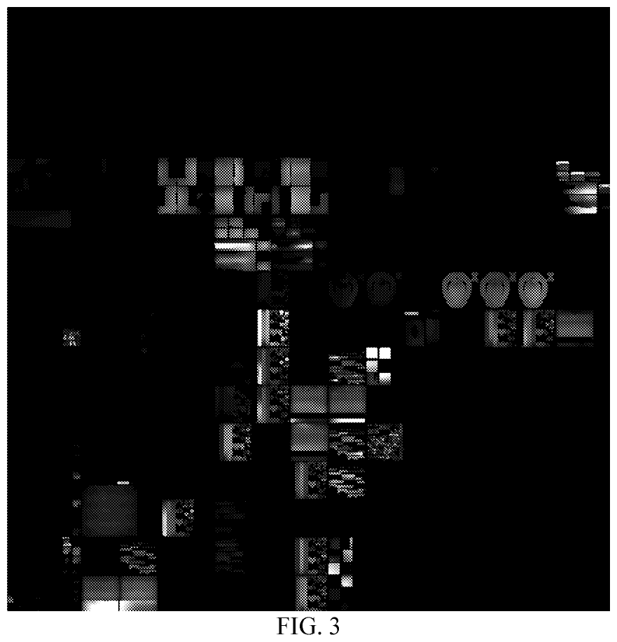

FIG. 3 is a schematic diagram of an illumination map of a to-be-rendered scene according to an embodiment of this disclosure. The figure represents the illumination map obtained by performing S201 to S203 for the to-be-rendered scene.

In an example of S201 to S203, the to-be-rendered scene is a scene X, and the allocated map of the to-be-rendered scene is a map X of the scene X. A computer device obtains a voxel texture formed by indirect illumination information of each voxel in a voxelized scene of the scene X, the voxel texture being a texture X, and the texture X including a plurality of voxels in the voxelized scene of the scene X and a plurality of indirect illumination corresponding to the plurality of voxels. The computer device collects the plurality of indirect illumination corresponding to the plurality of voxels in the texture X based on a plurality of rays emitted by each pixel in the map X of the scene X, to obtain indirect illumination of each pixel. The computer device stores, for a plurality of pixels in the map X, a plurality of indirect illumination corresponding to the plurality of pixels, to obtain an illumination map of the scene X, the illumination map being a map X′.

S204: Perform illumination sampling on the illumination map according to a to-be-rendered position of a to-be-rendered object in the to-be-rendered scene and an allocated area of the to-be-rendered object in the allocated map, to obtain indirect illumination of the to-be-rendered position. In some examples, illumination sampling is performed on the illumination map by processing circuitry based on one or more to-be-rendered positions of one or more to-be-rendered objects in the to-be-rendered scene and one or more allocated areas of the one or more to-be-rendered objects in the allocated map, to obtain indirect illumination of the one or more to-be-rendered positions. In some examples, the to-be-rendered scene is rendered for display based on the indirect illumination of the one or more to-be-rendered positions.

In this disclosure, after the illumination map of the to-be-rendered scene is obtained by performing S201 to S203, a pixel in the illumination map of the to-be-rendered scene may represent a pixel on a surface of the to-be-rendered object in the to-be-rendered scene, and the allocated map means re-allocation on the to-be-rendered object in the to-be-rendered scene, and a pixel included in the allocated map has a clear correspondence with the illumination map.

Therefore, based on indirect illumination provided by a pixel in the illumination map of the to-be-rendered scene, indirect illumination of a pixel corresponding to the to-be-rendered position in the illumination map may be sampled based on the to-be-rendered position of the to-be-rendered object in the to-be-rendered scene and the allocated area of the to-be-rendered object in the allocated map, to obtain the indirect illumination of the to-be-rendered position.

The to-be-rendered position of the to-be-rendered object in the to-be-rendered scene is texture coordinates of the to-be-rendered object in the to-be-rendered scene. The allocated area of the to-be-rendered object in the allocated map may be identified based on corresponding texture coordinate offsets of the allocated area in the allocated map. An allocated size of the allocated area of the to-be-rendered object in the allocated map is a corresponding area size of the allocated area in the allocated map.

For the to-be-rendered position of the to-be-rendered object in the to-be-rendered scene in S204, because indirect illumination is provided on a pixel in the illumination map of the to-be-rendered scene, indirect illumination of a corresponding pixel in the illumination map may be sampled based on the allocated area of the to-be-rendered object in the allocated map, and indirect illumination calculation is rapidly implemented, to rapidly obtain the indirect illumination of the to-be-rendered position.

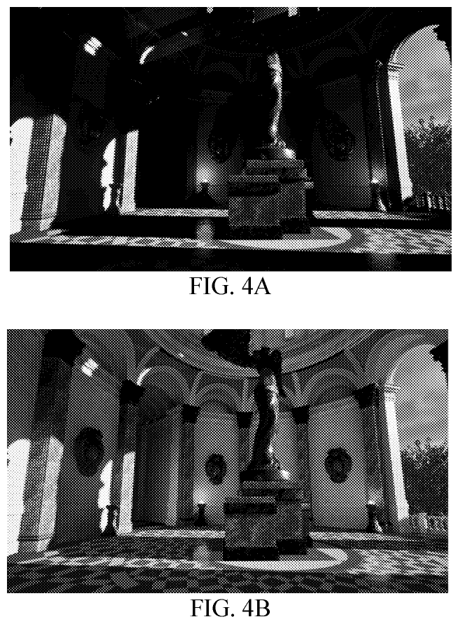

FIGS. 4A and 4B are schematic diagrams of different rendering effects of a to-be-rendered scene according to an embodiment of this disclosure. FIG. 4A includes a rendering effect diagram of a to-be-rendered scene when indirect illumination is turned off. FIG. 4B includes a rendering effect diagram of the to-be-rendered scene obtained by starting the indirect illumination processing method provided in this disclosure, which may correspond to a rendering effect diagram of the to-be-rendered scene obtained by performing S204 based on the illumination map of the to-be-rendered scene represented in FIG. 3.

In an example of S204, based on the foregoing example of S201 to S203, the to-be-rendered object is an object, and the to-be-rendered position of the to-be-rendered object in the to-be-rendered scene is texture coordinates (u, v) of the object in the scene X. The computer device samples the map X′ based on the texture coordinates (u, v) of the object in the scene X and a position offset and an allocated size of the object in the map X, to obtain indirect illumination of (u, v).

In some aspects, illumination baking is rapidly implemented based on an allocated map of a to-be-rendered scene and depending on indirect illumination provided by voxels in a voxel texture of the to-be-rendered scene, to obtain an illumination map of the to-be-rendered scene. The illumination map is sampled based on a to-be-rendered position of a to-be-rendered object in the to-be-rendered scene and depending on a position offset and an allocated size of the to-be-rendered object in the allocated map, and indirect illumination calculation is rapidly implemented, to obtain indirect illumination of the to-be-rendered position. In other words, according to the method, indirect illumination calculation is performed without depending on generation of a screen probe or a surface finite element based on geometry information of a vertex in a geometry cache of the to-be-rendered scene, so that indirect illumination calculation is relatively simple and direct, which may save more time, and indirect illumination calculation efficiency based on a rendering scene may be improved.

In this disclosure, the allocated map of the to-be-rendered scene in S202 is a two-dimensional map obtained by allocating an area for a resolution of each to-be-rendered object in the to-be-rendered scene in an initial map. Therefore, a process of obtaining the allocated map of the to-be-rendered scene includes: first determining a position offset and an allocated size of a to-be-allocated area of each to-be-rendered object in the initial map according to a resolution of each to-be-rendered object in the to-be-rendered scene; and then performing area allocation on the initial map according to the position offset and the allocated size of the to-be-allocated area of each to-be-rendered object in the initial map, to obtain the allocated map, a position offset and an allocated size of a to-be-allocated area of a to-be-rendered object in the allocated map being a position offset and an allocated size of the to-be-rendered object in the allocated map. Based on this, this disclosure provides a possible implementation. The operation of obtaining the allocated map of the to-be-rendered scene in S202 may include, for example, the following S1 and S2 (not shown in the figure).

S1: Determine a position offset and an allocated size of each to-be-rendered object in an initial map according to a resolution of each to-be-rendered object in the to-be-rendered scene.

S2: Perform area allocation on the initial map according to the position offset and the allocated size of each to-be-rendered object in the initial map, to obtain the allocated map.

The position offset of each to-be-rendered object in the initial map is a texture coordinate offset corresponding to a to-be-allocated area of each to-be-rendered object in the initial map. The allocated size of each to-be-rendered object in the initial map is an area size corresponding to the to-be-allocated area of each to-be-rendered object in the initial map.

For the initial map in S1 and S2, the position offset and the allocated size of the to-be-allocated area of each to-be-rendered object in the initial map are determined according to the resolution of each to-be-rendered object in the to-be-rendered scene, and area allocation is performed on the initial map, to obtain the accurate allocated map of the to-be-rendered scene, so that a pixel in the allocated map of the to-be-rendered scene may represent a surface point of the to-be-rendered object in the to-be-rendered scene, to provide an accurate basic map for subsequently collecting a plurality of indirect illumination corresponding to a plurality of voxels in the voxel texture based on a plurality of rays emitted by the pixel and correspondingly storing the plurality of indirect illumination, to rapidly implement illumination baking.

In an example of S1 and S2, based on the foregoing example of S201 to S203, the to-be-rendered object is an object, and the initial map is a map x. The computer device determines a position offset and an allocated size of a to-be-allocated area of each object in the map x according to a resolution of each object in the scene x; and the computer device performs area allocation on the map x according to the position offset and the allocated size of the to-be-allocated area of each object in the map X, to obtain the map X.

In this disclosure, during specific implementation of collecting the plurality of indirect illumination corresponding to the plurality of voxels in the voxel texture based on the plurality of first rays emitted by each pixel in the allocated map of the to-be-rendered scene, to obtain the indirect illumination of each pixel in S202, for each pixel, all the plurality of indirect illumination corresponding to the plurality of voxels in the voxel texture that is hit by each first ray emitted by the pixel may be collected, to obtain the indirect illumination collected based on each first ray, and the plurality of indirect illumination are collected based on the plurality of first rays. In this case, the plurality of indirect illumination collected based on the plurality of first rays further needs to be mixed, to obtain the indirect illumination of the pixel. Therefore, based on the plurality of indirect illumination collected based on the plurality of first rays, considering that a normal direction of the pixel, a ray direction of each first ray, probability densities of ray directions respectively corresponding to the plurality of rays, and a quantity of first rays affect a degree of contribution of indirect illumination collected based on each first ray to the indirect illumination of the pixel, a first weight of each first ray is determined based on the normal direction of the pixel, the ray direction of each first ray, the probability densities of the plurality of ray directions corresponding to the plurality of first rays, and the quantity of the plurality of first rays; and then weighting calculation is performed with reference to the plurality of indirect illumination collected based on the plurality of first rays and a plurality of first weights corresponding to the plurality of first rays, to obtain the indirect illumination of the pixel. Based on this, this disclosure provides a possible implementation. S202 may include, for example, the following S2021 to S2023 (not shown in the figure).

S2021: Perform, for each pixel according to the plurality of first rays emitted by the pixel, illumination collection on the indirect illumination corresponding to the voxels in the voxel texture, to obtain a plurality of indirect illumination collected based on the plurality of first rays.

S2022: Determine a first weight of each first ray according to a normal direction of the pixel, a ray direction of each first ray, probability densities of ray directions respectively corresponding to the plurality of first rays, and a quantity of the plurality of first rays.

S2023: Perform weighting calculation according to the indirect illumination respectively collected based on the plurality of first rays and first weights respectively corresponding to the plurality of first rays, to obtain the indirect illumination of the pixel. For example, a weighted combination of the plurality of pieces of indirect illumination is performed based on the plurality of first rays and the corresponding first weights, to obtain the respective indirect illumination of the pixel.

The indirect illumination respectively collected based on the first rays is collected illumination formed by the plurality of indirect illumination corresponding to the plurality of voxels in the voxel texture hit by the first rays. The normal direction of the pixel is a normal direction of the surface point of the to-be-rendered object in the to-be-rendered scene represented by the pixel. The ray direction of each first ray is an emitting direction of each first ray. The probability densities of the ray directions respectively corresponding to the plurality of first rays are emitting probabilities of the ray directions respectively corresponding to the plurality of first rays. The first weight of each first ray is a degree of contribution of the indirect illumination collected based on each first ray to the indirect illumination of the pixel.

In S2021 to S2023, for each pixel in the allocated map of the to-be-rendered scene, weighting calculation is performed based on the indirect illumination collected based on each first ray emitted by the pixel and the first weight of each first ray determined according to the normal direction of the pixel, the ray direction of each first ray, the probability densities of the plurality of ray directions corresponding to the plurality of first rays, and the quantity of the plurality of first rays. Considering a degree of contribution of the indirect illumination collected based on each first ray to the indirect illumination of the pixel, the plurality of indirect illumination collected based on the plurality of first rays is mixed, to obtain accurate indirect illumination of the pixel, to provide accurate indirect illumination data for subsequently corresponding storage and rapidly implementing illumination baking, to obtain the illumination map.

In an example of S2021 to S2023, based on the foregoing example of S201 to S203, the normal direction of the pixel is PixelNormal, the ray direction of the first ray is RaylDirection, the probability densities of the ray directions respectively corresponding to the plurality of first rays are Pdf1, and the quantity of the plurality of first rays is N1. The computer device collects, for each pixel based on each first ray emitted by the pixel, the plurality of indirect illumination corresponding to the plurality of voxels in the texture X, to obtain indirect illumination collected based on each first ray, to obtain the plurality of indirect illumination collected based on the plurality of first rays. The computer device first determines a first weight of each first ray based on PixelNormal, each RaylDirection, each Pdf1, and N1, and then performs weighting calculation with reference to the plurality of indirect illumination collected based on the plurality of first rays and a plurality of first weights corresponding to the plurality of first rays, to obtain the indirect illumination of the pixel. A calculation formula of the first weight of the first ray is as follows:

$$weight 1 = \frac{PixelNormal \times Ray 1 Direction}{N 1 \times Pdf 1}$$

weight1 represents the first weight of the first ray.

In this disclosure, the voxelized scene of the to-be-rendered scene in S201 is a scene in which a voxel represents each to-be-rendered object in the to-be-rendered scene. Therefore, each to-be-rendered object in the to-be-rendered scene is converted into a voxel for representation, to obtain the voxelized scene of the to-be-rendered scene. Based on this, this disclosure provides a possible implementation. The operation of obtaining the voxelized scene of the to-be-rendered scene in S201 may include, for example, S3 (not shown in the figure): Perform voxel conversion on each to-be-rendered object in the to-be-rendered scene, to obtain the voxelized scene.

The voxel conversion means that a voxel represents a to-be-rendered object.

Each to-be-rendered object in the to-be-rendered scene is converted to a voxel for representation to obtain the voxelized scene in S3, to lay a foundation of subsequently collecting the indirect illumination of the voxel in the voxelized scene and correspondingly storing the indirect illumination, to form the voxel texture.

FIG. 5 is a schematic diagram of a voxelized scene of a to-be-rendered scene according to an embodiment of this disclosure. The figure represents the voxelized scene of the to-be-rendered scene obtained by performing S3 for the to-be-rendered scene.

In an example of S3, based on the foregoing example of S201 to S203, the to-be-rendered object is an object. The computer device converts each object in the scene X into a voxel for representation, to obtain a voxelized scene of the scene X.

In this disclosure, the voxel texture of the to-be-rendered scene in S201 is a three-dimensional texture formed by the indirect illumination information of each voxel stored for each voxel in the voxelized scene of the to-be-rendered scene. The indirect illumination information of each voxel is hybrid illumination of direct illumination of a scene light source and stored illumination of another voxel that are collected based on a plurality of rays emitted by each voxel. Therefore, a process of obtaining the voxel texture of the to-be-rendered scene includes: first collecting the direct illumination of the scene light source of the to-be-rendered scene and the stored illumination of the another voxel in the voxelized scene based on a plurality of second rays emitted by each voxel in the voxelized scene of the to-be-rendered scene, to obtain indirect illumination information of each voxel; and then storing, for a plurality of voxels in the voxelized scene, indirect illumination respectively corresponding to the plurality of voxels, to obtain the voxel texture. Based on this, this disclosure provides a possible implementation. The operation of obtaining the voxel texture of the to-be-rendered scene in S201 may include, for example, the following S4 and S5.

S4: Perform illumination collection on direct illumination of a scene light source of the to-be-rendered scene and stored illumination of another voxel in the voxelized scene according to a plurality of second rays emitted by each voxel, to obtain indirect illumination information of each voxel. For example, the indirect illumination information of each voxel in the voxelized scene is obtained based on a plurality of second rays emitted by the corresponding voxel and a scene light source of the to-be-rendered scene.

S5: Store, for a plurality of voxels in the voxelized scene, indirect illumination respectively corresponding to the plurality of voxels, to obtain the voxel texture.

In S4 and S5, the indirect illumination of the scene light source of the to-be-rendered scene and the stored illumination of the another voxel in the voxelized scene are collected based on the plurality of second rays emitted by each voxel in the voxelized scene of the to-be-rendered scene, so that indirect illumination of voxels may be rapidly collected and correspondingly stored, to obtain the voxel texture of the to-be-rendered scene, to provide collectable indirect illumination of a voxel for subsequently rapidly implementing illumination baking based on the allocated map of the to-be-rendered scene, to obtain the illumination map.

In an example of S4 and S5, based on the foregoing example of S201 to S203, the computer device collects, based on a plurality of second rays emitted by each voxel in the voxelized scene of the scene X, direct illumination of a scene light source of the scene X and stored illumination of another voxel in the voxelized scene, to obtain indirect illumination information of each voxel. The computer device stores, for a plurality of voxels in the voxelized scene, a plurality of indirect illumination corresponding to the plurality of voxels, to obtain the texture X.

In this disclosure, during specific implementation of collecting, based on the plurality of second rays emitted by each voxel in the voxelized scene of the to-be-rendered scene, the direct illumination of the scene light source of the to-be-rendered scene and the stored illumination of the another voxel in the voxelized scene, to obtain the indirect illumination information of each voxel, for each voxel, the direct illumination of the scene light source hit by each second ray emitted by the voxel and the stored illumination of the another voxel may be collected, to obtain the indirect illumination collected based on each second ray, so as to obtain the plurality indirect illumination collected based on the plurality of second rays. In this case, the indirect illumination collected based on the second rays further needs to be mixed, to obtain the indirect illumination of the voxel. Therefore, based on the plurality of indirect illumination collected based on the plurality of second rays, considering that all a normal direction of the voxel, a ray direction of each second ray, probability densities of ray directions respectively corresponding to the plurality of second rays, and a quantity of the plurality of second rays affect a degree of contribution of the indirect illumination collected based on each second ray to the indirect illumination of the voxel, a second weight of each second ray is first determined based on the normal direction of the voxel, the ray direction of each second ray, the probability densities of the ray directions respectively corresponding to the plurality of second rays, and the quantity of the plurality of second rays; and then weighting calculation is performed with reference to the plurality of indirect illumination collected based on the plurality of second rays and a plurality of second weights corresponding to the plurality of second rays, to obtain the indirect illumination of the voxel. Based on this, this disclosure provides a possible implementation. S4 may include, for example, the following S41 to S43 (not shown in the figure).

S41: Perform, for each voxel, illumination collection on the direct illumination of the scene light source and the stored illumination of the another voxel according to the plurality of second rays emitted by the voxel, to obtain a plurality of indirect illumination collected based on the plurality of second rays.

S42: Determine a second weight of each second ray according to a normal direction of the voxel, a ray direction of each second ray, probability densities of ray directions respectively corresponding to the plurality of second rays, and a quantity of the plurality of second rays.

S43: Perform weighting calculation according to the indirect illumination respectively collected based on the plurality of second rays and second weights respectively corresponding to the plurality of second rays, to obtain the indirect illumination of the voxel.

The plurality of indirect illumination collected based on the plurality of second rays is a plurality of collected illumination formed by the direct illumination of the scene light source hit by the plurality of second rays and the stored illumination of the another voxel. The normal direction of the voxel is a normal direction of a three-dimensional grid of the to-be-rendered object in the to-be-rendered scene represented by the voxel. The ray direction of each second ray is an emitting direction of each second ray. The probability densities of the plurality of ray directions corresponding to the plurality of second rays are a plurality of emitting probabilities corresponding to the plurality of ray directions corresponding to the plurality of second rays. The second weight of each second ray is a degree of contribution of the indirect illumination collected based on each second ray to the indirect illumination of the voxel.

In S41 to S43, for each voxel in the voxel texture of the to-be-rendered scene, weighting calculation is performed based on the indirect illumination collected based on each second ray emitted by the voxel and the second weight of each second ray determined according to the normal direction of the voxel, the ray direction of each second ray, the probability densities of the plurality of ray directions corresponding to the plurality of second rays, and the quantity of the plurality of second rays. Considering a degree of contribution of the indirect illumination collected based on each second ray to the indirect illumination of the voxel, the plurality of indirect illumination collected based on the plurality of second rays is mixed, to obtain accurate indirect illumination of the voxel, to provide accurate indirect illumination data for subsequently corresponding storage to obtain the voxel texture.

In an example of S41 to S43, based on the foregoing example of S4 and S5, the normal direction of the voxel is VoxelNormal, the ray direction of the second ray is Ray2Direction, the probability densities of the plurality of ray directions corresponding to the plurality of second rays are Pdf2, and the quantity of the plurality of second rays is N2. The computer device collects, for each voxel based on each second ray emitted by the voxel, the direct illumination of the scene light source and the stored illumination of the another voxel, to obtain indirect illumination collected based on each second ray, so as to obtain a plurality of indirect illumination collected based on the plurality of second rays. The computer device first determines a second weight of each second ray based on VoxelNormal, each Ray2Direction, each Pdf2, and N2, and then performs weighting calculation with reference to the plurality of indirect illumination collected based on the plurality of second rays and a plurality of second weights corresponding to the plurality of second rays, to obtain the indirect illumination of the voxel. A calculation formula of the second weight of the second ray is as follows:

$$weight 2 = \frac{VoxelNormal \times Ray 2 Direction}{N 2 \times Pdf 2}$$

weighted t2 represents the second weight of the second ray.

In this disclosure, during specific implementation of sampling, based on the to-be-rendered position of the to-be-rendered object in the to-be-rendered scene and the position offset and the allocated size of the to-be-rendered object in the allocated map, indirect illumination of a pixel corresponding to the to-be-rendered position in the illumination map, to obtain the indirect illumination of the to-be-rendered position in S204, because the pixel in the illumination map of the to-be-rendered scene may represent a surface point of the to-be-rendered object in the to-be-rendered scene, a pixel position of a pixel corresponding to the to-be-rendered position in the illumination map may be determined as the to-be-sampled position based on the to-be-rendered position of the to-be-rendered object in the to-be-rendered scene and the position offset and the allocated size of the to-be-rendered object in the allocated map. Based on this, indirect illumination of a pixel of the to-be-sampled position is sampled in the illumination map, to obtain the indirect illumination of the to-be-rendered position. Based on this, this disclosure provides a possible implementation. S204 may include, for example, the following S2041 and S2042 (not shown in the figure).

S2041: Determine a to-be-sampled position of the to-be-rendered position in the illumination map according to the to-be-rendered position of the to-be-rendered object in the to-be-rendered scene and the allocated area of the to-be-rendered object in the allocated map.

S2042: Perform illumination sampling on the illumination map according to the to-be-sampled position, to obtain the indirect illumination of the to-be-rendered position.

The to-be-sampled position of the to-be-rendered position in the illumination map is a pixel position of a pixel corresponding to the to-be-rendered position in the illumination map.

In S2041 to S2042, considering a status of the allocated area of the to-be-rendered object in the allocated map, the pixel position of the pixel corresponding to the to-be-rendered object in the illumination map may be accurately determined as the to-be-sampled position according to the to-be-rendered position of the to-be-rendered object in the to-be-rendered scene and the position offset and the allocated size of the to-be-rendered object in the allocated map; and then the indirect illumination of the pixel of the to-be-sampled position is sampled in the illumination map, so that the indirect illumination of the to-be-rendered position may be accurately obtained.

In an example of S2041 to S2042, based on the foregoing example of S204, the computer device determines, based on (u, v) of the object in the scene X and the position offset and the allocated size of the object in the map X, that a pixel position of a pixel corresponding to the object in the map X′ is a to-be-sampled position (u′, v′); and the computer device samples indirect illumination of a pixel of (u′, v′) in the map X′, to obtain the indirect illumination of (u, v).

In addition, in this disclosure, considering that in an illumination rendering process of the to-be-rendered scene, the scene light source of the to-be-rendered scene may change, and a changed scene light source causes indirect illumination information of each voxel in the voxelized scene of the to-be-rendered scene to change, so that the voxel texture of the to-be-rendered scene changes. Therefore, when the scene light source of the to-be-rendered scene changes, the changed scene light source needs to be acquired, to update the voxel texture of the to-be-rendered scene based on the changed scene light source. Based on this, this disclosure provides a possible implementation. The method may further include, for example, the following S6 and S7 (not shown in the figure).

S6: Obtain a changed scene light source if the scene light source changes.

S7: Update the voxel texture according to the changed scene light source.

In S6 and S7, for a case in which the scene light source of the to-be-rendered scene changes, the voxel texture of the to-be-rendered scene is updated based on the changed scene light source, to provide more accurate indirect illumination of a voxel for subsequently rapidly implementing illumination baking based on the allocated map of the to-be-rendered scene to obtain the illumination map.

In an example of S6 and S7, based on the foregoing examples of S201 to S203 and S204, when a scene light source of the scene X changes, the computer device obtains a changed scene light source; and the computer device updates the texture X of the scene X based on the changed scene light source.

In this disclosure, considering that the changed scene light source affects the direct illumination of the scene light source of the to-be-rendered scene and the stored illumination of the another voxel in the voxelized scene, the indirect illumination information of each voxel in the voxelized scene of the to-be-rendered scene changes, so that the voxel texture of the to-be-rendered scene changes. Therefore, during specific implementation of updating the voxel texture of the to-be-rendered scene based on the changed scene light source in S7, each voxel in the voxelized scene of the to-be-rendered scene needs to emit more third rays, so that direct illumination of the changed scene light source and the stored illumination of the another voxel in the voxelized scene are recollected, to obtain updated indirect illumination information of each voxel. Therefore, the voxel texture of the to-be-rendered scene is updated based on a plurality of updated indirect illumination corresponding to the plurality of voxels. Based on this, this disclosure provides a possible implementation. S7 may include, for example, the following S71 and S72 (not shown in the figure).

S71: Perform illumination collection on direct illumination of the changed scene light source and the stored illumination of the another voxel according to a plurality of third rays emitted by each voxel, to obtain updated indirect illumination information of each voxel.

S72: Update the voxel texture according to updated indirect illumination respectively corresponding to the plurality of voxels.

The updated indirect illumination information of each voxel is hybrid illumination of the direct illumination of the changed scene light source and the stored illumination of the another voxel that are collected based on the plurality of rays emitted by each voxel.

In S71 and S72, each voxel in the voxelized scene of the to-be-rendered scene emits a plurality of third rays again, and the direct illumination of the changed scene light source of the to-be-rendered scene and the stored illumination of the another voxel in the voxelized scene are recollected, so that indirect illumination of a voxel may be rapidly recollected when the scene light source changes, and the voxel texture of the to-be-rendered scene is updated, to provide more accurate indirect illumination of the voxel for subsequently rapidly implementing illumination baking based on the allocated map of the to-be-rendered scene to obtain the illumination map.

In an example of S71 to S72, based on the foregoing example of S6 and S7, the computer device recollects, based on a plurality of third rays emitted by each voxel in the voxelized scene of the scene X, direct illumination of a changed scene light source and the stored illumination of the another voxel in the voxelized scene, to obtain updated indirect illumination information of each voxel; and the computer device updates the texture X of the scene X based on a plurality of updated indirect illuminations corresponding to the plurality of voxels.

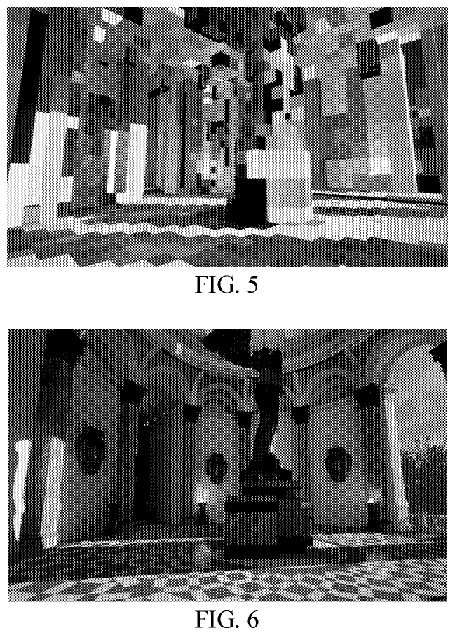

FIG. 6 is a schematic diagram of a rendering effect of a to-be-rendered scene after a scene light source changes according to an embodiment of this disclosure. The figure represents a rendering effect diagram of the to-be-rendered scene obtained by performing S6 and S71 and S72 based on FIG. 4B when the scene light source of the to-be-rendered scene changes.

In addition, in this disclosure, considering that in an illumination rendering process of the to-be-rendered scene, the to-be-rendered object in the to-be-rendered scene may move, that is, a plurality of voxels in the voxelized scene of the to-be-rendered scene may move, indirect illumination of each moved voxel in the voxelized scene changes due to the plurality of moved voxels, so that the voxel texture of the to-be-rendered scene changes. Therefore, when the to-be-rendered object in the to-be-rendered scene moves, a plurality of moved voxels in the voxelized scene of the to-be-rendered scene need to be obtained, so that the voxel texture of the to-be-rendered scene is updated based on the plurality of moved voxels. Based on this, this disclosure provides a possible implementation. The method may further include, for example, the following S8 and S9 (not shown in the figure).

S8: Obtain, if the to-be-rendered object moves, a plurality of moved voxels in the voxelized scene.

S9: Update the voxel texture according to the plurality of moved voxels.

The plurality of moved voxels in the voxelized scene are a plurality of three-dimensional grids of the plurality of moved to-be-rendered objects in the to-be-rendered scene. If the voxelized scene includes N voxels, the plurality of moved voxels in the voxelized scene are N moved voxels.

In S8 and S9, for a case in which the to-be-rendered object in the to-be-rendered scene moves, the voxel texture of the to-be-rendered scene is updated based on the plurality of moved voxels in the voxelized scene of the to-be-rendered scene, to provide more accurate indirect illumination of a voxel for subsequently rapidly implementing illumination baking based on the allocated map of the to-be-rendered scene to obtain the illumination map.

In an example of S8 and S9, based on the foregoing examples of S201 to S203 and S204, when the object in the scene X moves, the computer device needs to obtain a plurality of moved voxels in the voxelized scene of the scene X; and the computer device updates the texture X of the scene X based on the plurality of moved voxels.

In this disclosure, considering that indirect illumination of each moved voxel in the voxelized scene changes due to the plurality of moved voxels in the voxelized scene, the voxel scene of the to-be-rendered scene changes. Therefore, during specific implementation of updating the voxel texture of the to-be-rendered scene based on the plurality of moved voxels in S9, each moved voxel in the voxelized scene of the to-be-rendered scene needs to emit a plurality of fourth rays, so that the direct illumination of the scene light source and the stored illumination of the another voxel are recollected, to obtain updated indirect illumination of each moved voxel. Therefore, the voxel texture of the to-be-rendered scene is updated based on the plurality of moved voxels and a plurality of updated indirect illumination corresponding to the plurality of moved voxels. Based on this, this disclosure provides a possible implementation. S9 may include, for example, the following S91 and S92 (not shown in the figure).

S91: Perform illumination collection on the direct illumination of the scene light source and the stored illumination of the another voxel according to a plurality of fourth rays emitted by each moved voxel, to obtain updated indirect illumination of each moved voxel.

S92: Update the voxel texture according to the plurality of moved voxels and updated indirect illumination respectively corresponding to the plurality of moved voxels.

The updated indirect illumination of each moved voxel is hybrid illumination of the direct illumination of the scene light source and the stored illumination of the another voxel that are collected by a plurality of rays emitted by each moved voxel.

In S91 and S92, each moved voxel in the voxelized scene of the to-be-rendered scene emits the plurality of fourth rays again, and the direct illumination of the scene light source of the to-be-rendered scene and the stored illumination of the another voxel in the voxelized scene are recollected, so that the indirect illumination of the voxel may be rapidly recollected when the to-be-rendered object in the to-be-rendered scene moves, and the voxel texture of the to-be-rendered is updated, to provide more accurate indirect illumination of the voxel for subsequently rapidly implementing illumination baking based on the allocated map of the to-be-rendered scene to obtain the illumination map.

In an example of S91 to S92, based on the foregoing example of S8 and S9, the computer device recollects, based on a plurality of fourth rays emitted by each moved voxel in the voxelized scene of the scene X, the direct illumination of the scene light source and the stored illumination of the another voxel, to obtain updated indirect illumination of each moved voxel; and the computer device updates the texture X of the scene X based on the plurality of moved voxels and a plurality of updated indirect illumination corresponding to the plurality of moved voxels.

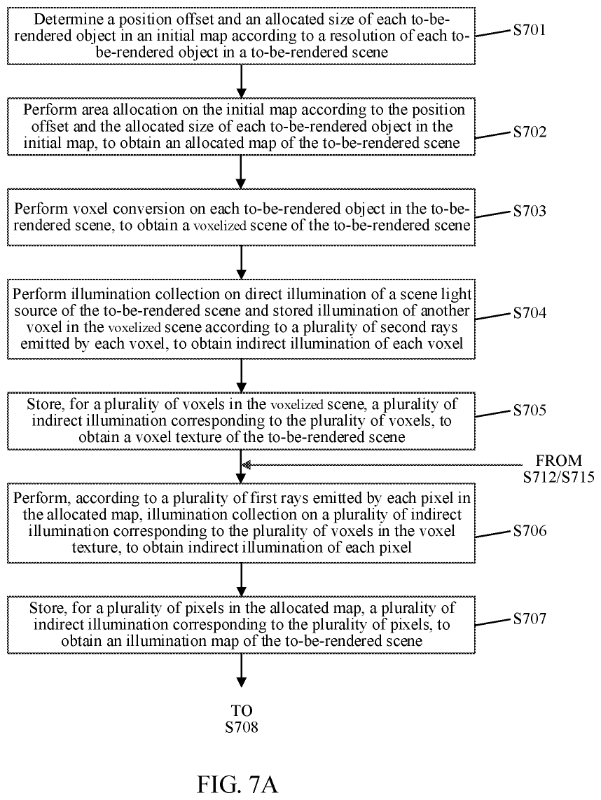

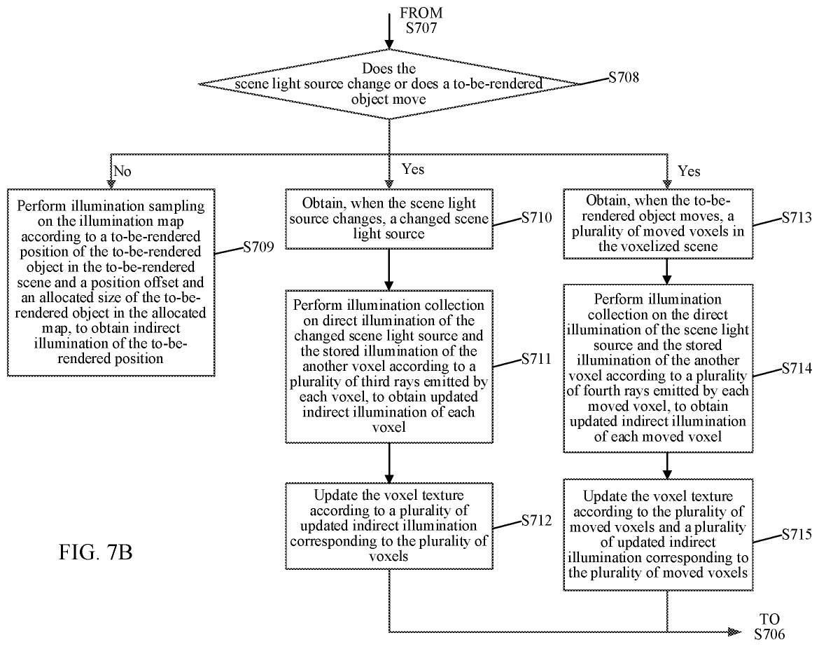

FIGS. 7A and 7B are portions of a flowchart of another indirect illumination processing method based on a rendering scene according to an embodiment of this disclosure. The method includes the following S701 to S715.

S701: Determine a position offset and an allocated size of each to-be-rendered object in an initial map according to a resolution of each to-be-rendered object in a to-be-rendered scene.

S702: Perform area allocation on the initial map according to the position offset and the allocated size of each to-be-rendered object in the initial map, to obtain an allocated map of the to-be-rendered scene.

S703: Perform voxel conversion on each to-be-rendered object in the to-be-rendered scene, to obtain a voxelized scene of the to-be-rendered scene.

S704: Perform illumination collection on direct illumination of a scene light source of the to-be-rendered scene and stored illumination of another voxel in the voxelized scene according to a plurality of second rays emitted by each voxel, to obtain indirect illumination information of each voxel.

S705: Store, for a plurality of voxels in the voxelized scene, a plurality of indirect illumination corresponding to the plurality of voxels, to obtain a voxel texture of the to-be-rendered scene.

S706: Perform, according to a plurality of first rays emitted by each pixel in the allocated map, illumination collection on a plurality of indirect illumination corresponding to the plurality of voxels in the voxel texture, to obtain indirect illumination of each pixel.

S707: Store, for a plurality of pixels in the allocated map, a plurality of indirect illumination corresponding to the plurality of pixels, to obtain an illumination map of the to-be-rendered scene.

S708: Determine whether the scene light source changes or whether the to-be-rendered object moves, and perform S709 if the scene light source does not change or the to-be-rendered object does not move; or perform S710 to S712 and return to S706 when the scene light source changes, and perform S713 to S715 and return to S706 when the to-be-rendered object moves.

S709: Perform illumination sampling on the illumination map according to a to-be-rendered position of the to-be-rendered object in the to-be-rendered scene and a position offset and an allocated size of the to-be-rendered object in the allocated map, to obtain indirect illumination of the to-be-rendered position.

S710: Obtain a changed scene light source.

S711: Perform illumination collection on direct illumination of the changed scene light source and the stored illumination of the another voxel according to a plurality of third rays emitted by each voxel, to obtain updated indirect illumination information of each voxel.

S712: Update the voxel texture according to a plurality of updated indirect illumination corresponding to the plurality of voxels.

S713: Obtain a plurality of moved voxels in the voxelized scene.

S714: Perform illumination collection on the direct illumination of the scene light source and the stored illumination of the another voxel according to a plurality of fourth rays emitted by each moved voxel, to obtain updated indirect illumination of each moved voxel.

S715: Update the voxel texture according to the plurality of moved voxels and a plurality of updated indirect illumination corresponding to the plurality of moved voxels.

In some aspects, illumination baking is rapidly implemented based on an allocated map of a to-be-rendered scene and depending on indirect illumination provided by voxels in a voxel texture of the to-be-rendered scene, to obtain an illumination map of the to-be-rendered scene. When a scene light source of the to-be-rendered scene does not change and a to-be-rendered object in the to-be-rendered scene does not move, the illumination map is sampled based on a to-be-rendered position of the to-be-rendered object in the to-be-rendered scene and depending on a position offset and an allocated size of the to-be-rendered object in the allocated map, and indirect illumination calculation is rapidly implemented to obtain indirect illumination of the to-be-rendered position. In addition, when the scene light source of the to-be-rendered scene changes, the voxel texture of the to-be-rendered scene is updated based on a changed scene light source. When the to-be-rendered object in the to-be-rendered scene moves, the voxel texture of the to-be-rendered scene is updated based on a plurality of moved voxels in a voxelized scene of the to-be-rendered scene. Therefore, when the scene light source of the to-be-rendered scene changes or the to-be-rendered object in the to-be-rendered scene moves, a voxel in an updated voxel texture provides accurate indirect illumination. In other words, according to the method, indirect illumination calculation is performed without depending on generation of a screen probe or a surface finite element based on geometry information of a vertex in a geometry cache of the to-be-rendered scene, so that indirect illumination calculation is relatively simple and direct, and more time may be saved. When the scene light source of the to-be-rendered scene does not change, and the to-be-rendered object in the to-be-rendered scene does not move, indirect illumination calculation time of the to-be-rendered scene is equivalent to sampling time of the illumination map. When the scene light source of the to-be-rendered scene changes or the to-be-rendered object in the to-be-rendered scene moves, the voxel texture of the to-be-rendered scene may be updated, to meet indirect illumination calculation for a dynamic change of the to-be-rendered scene. Based on this, according to the method, indirect illumination calculation efficiency and an indirect illumination calculation effect based on a rendering scene may be improved.

In this disclosure, based on the implementations according to the foregoing aspects, further combination may be performed, to provide more implementations.

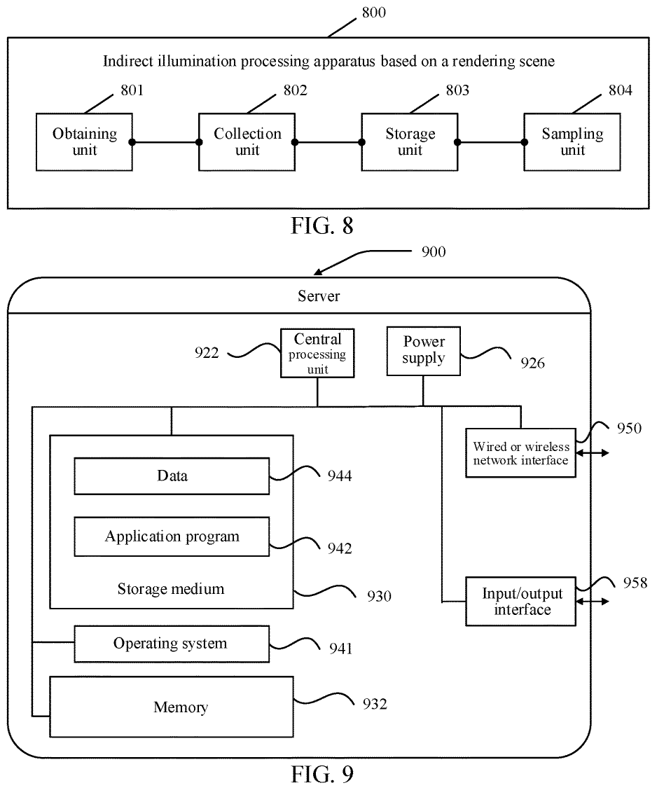

Based on the indirect illumination processing method based on a rendering scene provided in FIG. 2, an embodiment of this disclosure further provides an indirect illumination processing apparatus based on a rendering scene. FIG. 8 is a structural diagram of an indirect illumination processing apparatus based on a rendering scene according to an embodiment of this disclosure. The indirect illumination processing apparatus 800 based on a rendering scene includes: an obtaining unit 801, a collection unit 802, a storage unit 803, and a sampling unit 804.

The obtaining unit 801 is configured to obtain a voxel texture of a to-be-rendered scene, the voxel texture including indirect illumination information of each voxel in a voxelized scene of the to-be-rendered scene,

The collection unit 802 is configured to perform, according to a plurality of first rays emitted by each pixel in an allocated map of the to-be-rendered scene, illumination collection on indirect illumination corresponding to voxels in the voxel texture, to obtain indirect illumination of each pixel.

The storage unit 803 is configured to store, for a plurality of pixels in the allocated map, indirect illumination respectively corresponding to the plurality of pixels, to obtain an illumination map of the to-be-rendered scene.

The sampling unit 804 is configured to perform illumination sampling on the illumination map according to a to-be-rendered position of a to-be-rendered object in the to-be-rendered scene and an allocated area of the to-be-rendered object in the allocated map, to obtain indirect illumination of the to-be-rendered position.

In a possible implementation, the collection unit 802 is configured to:
perform, for each pixel according to the plurality of first rays emitted by the pixel, illumination collection on the indirect illumination corresponding to the voxels in the voxel texture, to obtain a plurality of indirect illumination collected based on the plurality of first rays;
determine a first weight of each first ray according to a normal direction of the pixel, a ray direction of each first ray, probability densities of ray directions respectively corresponding to the plurality of first rays, and a quantity of the plurality of first rays; and
perform weighting calculation according to the indirect illumination respectively collected based on the plurality of first rays and first weights respectively corresponding to the plurality of first rays, to obtain the indirect illumination of the pixel.

In a possible implementation, the collection unit 802 is further configured to:
perform illumination collection on direct illumination of a scene light source of the to-be-rendered scene and stored illumination of another voxel in the voxelized scene according to a plurality of second rays emitted by each voxel, to obtain the indirect illumination information of each voxel.

The storage unit 803 is further configured to:
store, for a plurality of voxels in the voxelized scene, indirect illumination respectively corresponding to the plurality of voxels, to obtain the voxel texture.

In a possible implementation, the collection unit 802 is configured to:
perform, for each voxel, illumination collection on the direct illumination of the scene light source and the stored illumination of the another voxel according to the plurality of second rays emitted by the voxel, to obtain a plurality of indirect illumination collected based on the plurality of second rays
determine a second weight of each second ray according to a normal direction of the voxel, a ray direction of each second ray, probability densities of ray directions respectively corresponding to the plurality of second rays, and a quantity of the plurality of second rays; and
perform weighting calculation according to the indirect illumination respectively collected based on the plurality of second rays and second weights respectively corresponding to the plurality of second rays, to obtain the indirect illumination of the voxel.

In a possible implementation, the apparatus 800 further includes: a conversion unit.

The conversion unit is configured to perform voxel conversion on each to-be-rendered object in the to-be-rendered scene, to obtain the voxelized scene.

In a possible implementation, the apparatus 800 further includes: a determining unit and an allocation unit.

The determining unit is configured to determine a position offset and an allocated size of each to-be-rendered object in an initial map according to a resolution of each to-be-rendered object in the to-be-rendered scene.

The allocation unit is configured to perform area allocation on the initial map according to the position offset and the allocated size of each to-be-rendered object in the initial map, to obtain the allocated map.

In a possible implementation, the sampling unit 804 is configured to:
determine, according to the to-be-rendered position of the to-be-rendered object in the to-be-rendered scene and the allocated area of the to-be-rendered object in the allocated map, a to-be-sampled position of the to-be-rendered position in the illumination map; and
perform illumination sampling on the illumination map according to the to-be-sampled position, to obtain the indirect illumination of the to-be-rendered position.

In a possible implementation, the apparatus further includes: a first update unit.

The obtaining unit 801 is further configured to obtain, if the scene light source changes, a changed scene light source.

The first update unit is configured to update the voxel texture according to the changed scene light source.

In a possible implementation, the first update unit is configured to:
performing illumination collection on direct illumination of the changed scene light source and the stored illumination of the another voxel according to a plurality of third rays emitted by each voxel, to obtain updated indirect illumination information of each voxel; and
update the voxel texture according to updated indirect illumination respectively corresponding to the plurality of voxels.

In a possible implementation, the apparatus further includes: a second update unit.

The obtaining unit 801 is further configured to obtain, if the to-be-rendered object moves, a plurality of moved voxels in the voxelized scene.

The second update unit is configured to update the voxel texture according to the plurality of moved voxels.

In a possible implementation, the second update unit is configured to:
perform illumination collection on the direct illumination of the scene light source and the stored illumination of the another voxel according to a plurality of fourth rays emitted by each moved voxel, to obtain updated indirect illumination of each moved voxel; and
update the voxel texture according to the plurality of moved voxels and updated indirect illumination respectively corresponding to the plurality of moved voxels.

In some aspects, the indirect illumination processing apparatus based on a rendering scene includes the obtaining unit, the collection unit, the storage unit, and the sampling unit. The obtaining unit first obtains a voxel texture formed by indirect illumination information of each voxel in a voxelized scene of a to-be-rendered scene; the collection unit then collects, based on a plurality of first rays emitted by each pixel in an allocated map of the to-be-rendered scene, a plurality of indirect illumination corresponding to a plurality of voxels in the voxel texture, to obtain indirect illumination of each pixel; the storage unit stores, for a plurality of pixels in the allocated map, a plurality of indirect illumination corresponding to the plurality of pixels, to obtain an illumination map of the to-be-rendered scene; and the obtaining unit, the collection unit, and the storage unit collect, based on the indirect illumination provided by the voxels in the voxel texture of the to-be-rendered scene for the allocated map of the to-be-rendered scene, the indirect illumination of the voxels in the voxel texture based on the plurality of first rays emitted by the pixel and correspondingly store the indirect illumination of the voxels, so that illumination baking may be rapidly implemented, to obtain an illumination map of the to-be-rendered scene. The sampling unit samples the illumination map based on a to-be-rendered position of a to-be-rendered object in the to-be-rendered scene and a position offset and an allocated size of the to-be-rendered object in the allocated map, to obtain indirect illumination of the to-be-rendered position; and the sampling unit may sample, based on indirect illumination provided by a pixel in the illumination map of the to-be-rendered scene for the to-be-rendered position of the to-be-rendered object in the to-be-rendered scene, indirect illumination of a corresponding pixel in the illumination map based on the position offset and the allocated size of the to-be-rendered object in the allocated map, to rapidly obtain the indirect illumination of the to-be-rendered position. Based on this, according to the apparatus, illumination baking is rapidly implemented based on an allocated map of a to-be-rendered scene and depending on indirect illumination provided by voxels in a voxel texture of the to-be-rendered scene, to obtain an illumination map of the to-be-rendered scene. The illumination map is sampled based on a to-be-rendered position of a to-be-rendered object in the to-be-rendered scene and depending on a position offset and an allocated size of the to-be-rendered object in the allocated map, and indirect illumination calculation is rapidly implemented, to obtain indirect illumination of the to-be-rendered position. In other words, according to the apparatus, indirect illumination calculation is performed without depending on generation of a screen probe or a surface finite element based on geometry information of a vertex in a geometry cache of the to-be-rendered scene, so that indirect illumination calculation is relatively simple and direct, which may save more time, and indirect illumination calculation efficiency based on a rendering scene may be improved.

An embodiment of this disclosure further provides a computer device. The computer device may be a server. FIG. 9 is a structural diagram of a server according to an embodiment of this disclosure. A server 900 may vary greatly due to different configurations or performance, and may include processing circuitry (e.g., one or more processors, such as a central processing unit (CPU) 922), a memory 932, and one or more storage media 930 (for example, one or more mass storage devices) that store an application program 942 or data 944. The memory 932 and the storage medium 930 may be transient or persistent storages (e.g., including a non-transitory computer-readable storage medium). The program stored in the storage medium 930 may include one or more modules (not shown in the figure), and each module may include a series of instructions and operations for the server. Still further, the CPU 922 may be configured to communicate with the storage medium 930, and perform, on the server 900, a series of instructions and operations in the storage medium 930.

The server 900 may further include one or more power supplies 926, one or more wired or wireless network interfaces 950, one or more input/output interfaces 958, and/or one or more operating systems 941, for example, Windows Server™, Mac OS X™, Unix™, Linux™, FreeBSD™ and the like.

In one or more embodiments, the central processing unit 922 in the server 900 may perform the methods provided in various optional implementations of the foregoing embodiments.

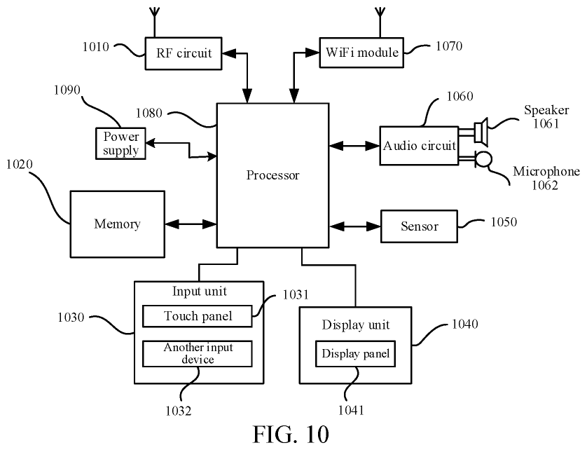

A computer device provided in an embodiment of this disclosure may alternatively be a terminal. FIG. 10 is a structural diagram of a terminal according to an embodiment of this disclosure. An example in which the terminal is a smartphone is used. The smartphone includes components such as a radio frequency (RF) circuit 1010, a memory 1020, an input unit 1030, a display unit 1040, a sensor 1050, an audio circuit 1060, a Wi-Fi module 1070, processing circuitry (e.g., a processor 1080), and a power supply 1090. The input unit 1030 may include a touch panel 1031 and another input device 1032, the display unit 1040 may include a display panel 1041, and the audio circuit 1060 may include a speaker 1061 and a microphone 1062. A person skilled in the art may understand that a structure of the electronic device shown in FIG. 10 does not constitute a limitation to the electronic device, and the electronic device may include more components or fewer components than those shown in the figure, or some components may be combined, or a different component deployment may be used.

The memory 1020 may include a non-transitory computer-readable storage medium configured to store the software program and the module. The processor 1080 runs the software program and module stored in the memory 1020, to implement various functional applications and data processing of the smartphone. The memory 1020 may mainly include a program storage region and a data storage region. The program storage region may store the operating system, an application program required by at least one function (such as a sound playback function and an image display function), and the like. The data storage region may store data (such as audio data and an address book) created according to use of the electronic device, and the like. In addition, the memory 1020 may include a high speed random access memory, and may also include a non-volatile memory, such as at least one magnetic disk storage device, a flash memory, or another volatile solid-state storage device.

The processor 1080 is the control center of the smart phone, and is connected to various parts of the entire smart phone through various interfaces and lines. By running or executing the software program and/or module stored in the memory 1020, and invoking data stored in the memory 1020, the processor 1080 performs various functions and data processing of the smart phone. In some embodiments, the processor 1080 may include one or more processing units. In an example, the processor 1080 may integrate an application processor and a modem. The application processor mainly processes an operating system, a user interface, an application program, and the like. The modem mainly processes wireless communication. The foregoing modem may not be integrated into the processor 1080.

In at least one embodiment, the processor 1080 in the smartphone may perform the methods provided in one or more embodiments of this disclosure.

According to another aspect, an embodiment of this disclosure provides a non-transitory computer-readable storage medium, the non-transitory computer-readable storage medium being configured to store a computer program, and when the computer program runs on a computer device, the computer device being caused to perform the method according to one or more aspects of this disclosure.

According to an aspect of this disclosure, a computer program product is provided, including a computer program, the computer program being stored in a non-transitory computer-readable storage medium. Processing circuitry (e.g., a processor) of the computer device reads the computer program from the non-transitory computer-readable storage medium, and the processor executes the computer program, so that the computer device performs the methods provided in one or more aspects of this disclosure.

Descriptions of processes or structures corresponding to the foregoing accompanying drawings have respective focuses. For a part that is not described in further detail in a process or structure, reference may be made to related descriptions of another process or structure.

Terms such as “first”, “second” in the specification, the claims and the accompanying drawings described above in this disclosure are configured to distinguish similar objects and need not be configured to describe a particular order or sequence. Data used in this way is interchangeable in a proper case, so that one or more embodiments of this disclosure described herein may be implemented in a sequence except the sequence shown or described herein. In addition, the terms “including,” and “having” and any variations thereof are intended to cover non-exclusive inclusions, for example, a process, method, system, product or device that includes a series of steps or units is not necessarily limited to those steps or units that are clearly listed, but may include other steps or units that are not clearly listed or inherent to the process, method, product, or device.

In the several embodiments provided in this disclosure, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in one or more embodiments of this disclosure may be integrated into one processing unit, each of the units may exist alone physically, or two or more units are integrated into one unit. The integrated unit may be implemented in a form of hardware, or may be implemented in a form of a software function unit.

When the integrated unit is implemented in the form of a software functional unit and sold or used as an independent product, the integrated unit may be stored in a non-transitory computer-readable storage medium. Based on such an understanding, the technical solutions of this disclosure may be implemented in a form of a software product. The computer software product is stored in a non-transitory computer-readable storage medium and includes several instructions for instructing a computer device to perform all or some of the operations of the methods described in one or more embodiments of this disclosure. The non-transitory computer-readable storage medium may include any medium that can store program code, such as a USB flash drive, a removable hard disk, a read-only memory (ROM), a random access memory (RAM), a magnetic disk, or an optical disc.

In one or more embodiments of this disclosure, the term “module” or “unit” refers to a computer program with a predetermined function or a part of the computer program, and works together with other relevant parts to achieve a predetermined objective, and may be all or partially implemented through software, hardware (such as processing circuitry or a memory), or a combination thereof. Similarly, one processor (or a plurality of processors or memories) may be used for implementing one or more modules or units. In addition, each module or unit may be a part of an overall module or unit including a function of the module or unit.

As used herein, “at least one of A, B, or C” is intended to mean any one or any combination of A, B, and C, including A alone, B alone, C alone, A and B, A and C, B and C, and A, B and C. Similarly, “one of A or B” means A, B, or both.

The above embodiments are merely non-limiting examples of the present disclosure, and are not intended to limit the present disclosure. The technical solutions described in one or more embodiments of this disclosure may be modified or replaced. However, these modifications or substitutions without deviating from the spirit of the disclosure shall fall within the scope of this disclosure.

What is claimed is:

1. An illumination processing method, the method comprising:
obtaining a voxel texture of a to-be-rendered scene, the voxel texture including indirect illumination information of each voxel in a voxelized scene of the to-be-rendered scene;
obtaining respective indirect illumination of each pixel in an allocated map of the to-be-rendered scene based on a plurality of first rays emitted by the pixel and the indirect illumination information of corresponding voxels in the voxel texture;
storing, for a plurality of pixels in the allocated map, the indirect illumination of the plurality of pixels, to obtain an illumination map of the to-be-rendered scene; and
performing, by processing circuitry, illumination sampling on the illumination map based on one or more to-be-rendered positions of one or more to-be-rendered objects in the to-be-rendered scene and one or more allocated areas of the one or more to-be-rendered objects in the allocated map, to obtain indirect illumination of the one or more to-be-rendered positions, the to-be-rendered scene being rendered for display based on the indirect illumination of the one or more to-be-rendered positions.

2. The method according to claim 1, wherein the obtaining the respective indirect illumination of each pixel in the allocated map comprises:
for each pixel in the allocated map based on the plurality of first rays emitted by the pixel,
performing illumination collection on the indirect illumination information of the corresponding voxels in the voxel texture, to obtain a plurality of pieces of indirect illumination collected based on the plurality of first rays;
determining a first weight of each first ray based on a normal direction of the pixel, a ray direction of each first ray, probability densities of ray directions respectively corresponding to the plurality of first rays, and a quantity of the plurality of first rays; and
performing a weighted combination of the plurality of pieces of indirect illumination based on the plurality of first rays and the corresponding first weights, to obtain the respective indirect illumination of the pixel.

3. The method according to claim 1, further comprising:
performing voxel conversion on each to-be-rendered object in the to-be-rendered scene, to obtain the voxelized scene.

4. The method according to claim 1, further comprising:
determining a position offset and an allocated size of each to-be-rendered object in an initial map based on a resolution of the corresponding to-be-rendered object in the to-be-rendered scene; and
performing area allocation on the initial map according to the position offset and the allocated size of each to-be-rendered object in the initial map, to obtain the allocated map.

5. The method according to claim 1, wherein the performing illumination sampling on the illumination map comprises:
determining, based on the one or more to-be-rendered positions of the one or more to-be-rendered objects in the to-be-rendered scene and the one or more allocated areas of the one or more to-be-rendered objects in the allocated map, one or more to-be-sampled positions corresponding to the one or more to-be-rendered positions in the illumination map; and
performing illumination sampling on the illumination map based on the one or more to-be-sampled positions, to obtain the indirect illumination of the one or more to-be-rendered positions.

6. The method according to claim 1, wherein the obtaining the voxel texture comprises:
obtaining the indirect illumination information of each voxel in the voxelized scene based on a plurality of second rays emitted by the corresponding voxel and a scene light source of the to-be-rendered scene; and
storing, for a plurality of voxels in the voxelized scene, the respective indirect illumination information of the plurality of voxels, to obtain the voxel texture.

7. The method according to claim 6, wherein the obtaining the indirect illumination information of each voxel in the voxelized scene comprises:
performing, for each voxel in the voxelized scene, illumination collection on direct illumination of the scene light source and stored illumination of one or more other voxels in the voxelized scene based on the plurality of second rays emitted by the corresponding voxel, to obtain a plurality of pieces of indirect illumination collected based on the plurality of second rays;
determining a second weight of each second ray based on a normal direction of the voxel, a ray direction of each second ray, probability densities of ray directions respectively corresponding to the plurality of second rays, and a quantity of the plurality of second rays; and
performing a weighted combination of the plurality of pieces of indirect illumination based on the plurality of second rays and the corresponding second weights, to obtain the respective indirect illumination information of the voxel.

8. The method according to claim 6, further comprising:
when the scene light source is changed to a changed scene light source, updating the voxel texture based on the changed scene light source.

9. The method according to claim 8, wherein the updating the voxel texture comprises:
performing, for each voxel in the voxelized scene, illumination collection on direct illumination of the changed scene light source and the stored illumination of one or more other voxels based on a plurality of third rays emitted by each voxel, to obtain respective updated indirect illumination information of each voxel; and
updating the voxel texture based on the respective updated indirect illumination corresponding to the plurality of voxels.

10. The method according to claim 6, wherein the method further comprises:
obtaining, when a to-be-rendered object moves, a plurality of moved voxels in the voxelized scene; and
updating the voxel texture based on the plurality of moved voxels.

11. The method according to claim 10, wherein the updating the voxel texture based on the plurality of moved voxels comprises:
performing, for each voxel of the plurality of moved voxels, illumination collection on direct illumination of the scene light source and the stored illumination of one or more other voxels based on a plurality of fourth rays emitted by each moved voxel, to obtain respective updated indirect illumination of each moved voxel; and
updating the voxel texture based on the plurality of moved voxels and respective updated indirect illumination corresponding to the plurality of moved voxels.

12. An illumination processing apparatus, comprising:
processing circuitry configured to:
obtain a voxel texture of a to-be-rendered scene, the voxel texture including indirect illumination information of each voxel in a voxelized scene of the to-be-rendered scene;
obtain respective indirect illumination of each pixel in an allocated map of the to-be-rendered scene based on a plurality of first rays emitted by the pixel and the indirect illumination information of corresponding voxels in the voxel texture;
store, for a plurality of pixels in the allocated map, the indirect illumination of the plurality of pixels, to obtain an illumination map of the to-be-rendered scene; and
perform illumination sampling on the illumination map based on one or more to-be-rendered positions of one or more to-be-rendered objects in the to-be-rendered scene and one or more allocated areas of the one or more to-be-rendered objects in the allocated map, to obtain indirect illumination of the one or more to-be-rendered positions, the to-be-rendered scene being rendered for display based on the indirect illumination of the one or more to-be-rendered positions.

13. The illumination processing apparatus according to claim 12, wherein the processing circuitry is configured to:
perform illumination collection on the indirect illumination information of the corresponding voxels in the voxel texture, to obtain a plurality of pieces of indirect illumination collected based on the plurality of first rays;
determine a first weight of each first ray based on a normal direction of the pixel, a ray direction of each first ray, probability densities of ray directions respectively corresponding to the plurality of first rays, and a quantity of the plurality of first rays; and
perform a weighted combination of the plurality of pieces of indirect illumination based on the plurality of first rays and the corresponding first weights, to obtain the respective indirect illumination of the pixel.

14. The illumination processing apparatus according to claim 12, wherein the processing circuitry is configured to:
perform voxel conversion on each to-be-rendered object in the to-be-rendered scene, to obtain the voxelized scene.

15. The illumination processing apparatus according to claim 12, wherein the processing circuitry is configured to:
determine a position offset and an allocated size of each to-be-rendered object in an initial map based on a resolution of the corresponding to-be-rendered object in the to-be-rendered scene; and
perform area allocation on the initial map according to the position offset and the allocated size of each to-be-rendered object in the initial map, to obtain the allocated map.

16. The illumination processing apparatus according to claim 12, wherein the processing circuitry is configured to:
determine, based on the one or more to-be-rendered positions of the one or more to-be-rendered objects in the to-be-rendered scene and the one or more allocated areas of the one or more to-be-rendered objects in the allocated map, one or more to-be-sampled positions corresponding to the one or more to-be-rendered positions in the illumination map; and
perform illumination sampling on the illumination map based on the one or more to-be-sampled positions, to obtain the indirect illumination of the one or more to-be-rendered positions.

17. The illumination processing apparatus according to claim 12, wherein the processing circuitry is configured to:
obtain the indirect illumination information of each voxel in the voxelized scene based on a plurality of second rays emitted by the corresponding voxel and a scene light source of the to-be-rendered scene; and
store, for a plurality of voxels in the voxelized scene, the respective indirect illumination information of the plurality of voxels, to obtain the voxel texture.

18. The illumination processing apparatus according to claim 17, wherein the processing circuitry is configured to:
perform, for each voxel in the voxelized scene, illumination collection on direct illumination of the scene light source and stored illumination of one or more other voxels in the voxelized scene based on the plurality of second rays emitted by the corresponding voxel, to obtain a plurality of pieces of indirect illumination collected based on the plurality of second rays;
determine a second weight of each second ray based on a normal direction of the voxel, a ray direction of each second ray, probability densities of ray directions respectively corresponding to the plurality of second rays, and a quantity of the plurality of second rays; and
perform a weighted combination of the plurality of pieces of indirect illumination based on the plurality of second rays and the corresponding second weights, to obtain the respective indirect illumination information of the voxel.

19. The illumination processing apparatus according to claim 17, wherein the processing circuitry is configured to:
when the scene light source is changed to a changed scene light source,
perform, for each voxel in the voxelized scene, illumination collection on direct illumination of the changed scene light source and the stored illumination of one or more other voxels based on a plurality of third rays emitted by each voxel, to obtain respective updated indirect illumination information of each voxel; and
update the voxel texture based on the respective updated indirect illumination corresponding to the plurality of voxels.

20. A non-transitory computer-readable storage medium storing instructions, which when executed by a processor, cause the processor to perform an illumination processing method, the method comprising:
obtaining a voxel texture of a to-be-rendered scene, the voxel texture including indirect illumination information of each voxel in a voxelized scene of the to-be-rendered scene;
obtaining respective indirect illumination of each pixel in an allocated map of the to-be-rendered scene based on a plurality of first rays emitted by the pixel and the indirect illumination information of corresponding voxels in the voxel texture;
storing, for a plurality of pixels in the allocated map, the indirect illumination of the plurality of pixels, to obtain an illumination map of the to-be-rendered scene; and
performing illumination sampling on the illumination map based on one or more to-be-rendered positions of one or more to-be-rendered objects in the to-be-rendered scene and one or more allocated areas of the one or more to-be-rendered objects in the allocated map, to obtain indirect illumination of the one or more to-be-rendered positions, the to-be-rendered scene being rendered for display based on the indirect illumination of the one or more to-be-rendered positions.
